(19) United States
(12) Patent Application Publication
(10) Pub. No.: US 2007/0138662 A1
(43) Pub. Date: Jun. 21, 2007

(54) Closed evaporative cooling tower

(76) Inventors: Peng Chu Chiu, Taipei City (TW); Chih Hsien Huang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/305,292

(22) Filed: Dec. 19, 2005

(51) Int. Cl. B01F 3/04

(52) U.S. Cl. 261/154; 261/104; 261/DIG. 11

(57) ABSTRACT

A closed evaporative cooling tower includes a heat dissipating tube coil unit, a water supply device, an air supply device, an intake segregated flow pipe, and a discharge combined flow pipe. It is mainly to cover a porous material, which can absorb water, on the surface of metal tube in the air flow channel of the heat dissipating tube coil unit. To use a water supply device to supply water intermittently, so that water can be absorbed on the porous material. To use an air supply fan to blow air through the porous material quickly to evaporate water so as to the heat of the medium to be cooled (such as water) in the metal tube to get heat exchange effect. In addition, the porous material has moisture absorption and moisture reservation function, so water can be supplied periodically, and the secondary cooling system of traditional closed cooling tower is nit required. It has the features of energy conversation, small volume and cost reduction.

### BACKGROUND OF THE INVENTION

1. Field of the Invention

The present invention relates to a closed evaporative cooling tower which uses the latent heat exchange principle. It uses small amount of water as one of energy and small amount of electricity as the other energy. The present invention is an innovatory dry type evaporative cooling tower, it especially means a heat exchanger which can save electric power, protect the environment and reduce manufacturing cost.

2. Description of the Prior Art

The closed evaporative cooling tower is the only heat exchanger which can provide the cleanest water in various cooling towers. It is designed to completely seal the cooling medium in two sets of heat exchangers, where water in a heat exchanger is engaged in an endothermic reaction, while water in the other heat exchanger is engaged in an exothermic reaction. The water is continuously circulated in the connecting pipe by a pump to get continuous heat absorption and release. The closed cooling tower is one of above exothermic heat exchangers. Various research reports show that the closed cooling tower can conserve energy and reduce operation cost in the freezing and air-conditioning industry. The energy can be conserved because the operation efficiency can be maintained permanently. The operation cost can be reduced because the routine work such as maintenance, cleaning and anti-corrosion etc. can be reduced for the heat exchanger at the endothermic side.

FIG. 1 shows the design of traditional closed cooling tower. It is composed a case 10, which is covered by corrugated or honey nest type heat dissipating sheet 12 and many metal tube 131 to form heat dissipating .tube coil 13. It needs the secondary cooling system 15, which uses the secondary pump 151 to continuously suck the secondary cooling water from water tank 153 to water sprinkling device 152 to sprinkle on the top of heat dissipating sheet 12. The fan 142 of air supply device 14 is driven by fan motor 141 blows the free-falling water to generate upward draft and friction to release the sensible heat and latent heat of the secondary cooling water. When the secondary cooling water is leaving heat dissipating sheet, its temperature will be reduced, then the secondary cooling water is flowing through heat dissipating tube coil 13 to absorb the heat of cooling in metal tube 131. After the heat exchange, the cooling water is cooled, and the secondary cooling water is heated and dropped into water tank 253. A floating ball valve 154 is installed in water tank 153 to make up the evaporated water. It forms a cycle to reach a fixed heat exchange operation.

The above example is only one example of traditional closed cooling towers. There are some modification examples such as improve the direction of air flow or independent air flow of heat dissipating sheet 12 and heat dissipating tube coil 13, or the overlap of heat dissipating sheet 12 and heat dissipating tube coil 13 etc. But the secondary cooling system 15 is still required for these closed cooling towers. It will increase the energy consumption of the secondary pump 151 and the horsepower of fan motor 141 to sufficiently air flow through heat dissipating sheet 12 and heat dissipating tube coil 13. So the traditional closed cooling tower needs much more power than that of non-closed cooling tower. For 1 cooling ton (=3900 kcal/h), the efficiency is only about 40-50 kcal/hW, which is about 50% to other non-closed cooling tower. When compared to non-closed cooling tower, the traditional closed cooling tower needs more volume to place heat dissipating tube coil 13 and the secondary cooling system 15. Its volume is about 2 times, so that the cost and weight is increased. Due to these two disadvantages described above, the closed cooling tower could not popular in the market. Thus, the present invention is not the improvement of prior art, it is a brand new innovation.

### SUMMARY OF THE INVENTION

FIGS. 2 and 3 show the schematic diagrams of the present invention. There are a set or multiple sets of heat dissipating tube coil unit 21 in a case 20, wherein the heat dissipating tube coil unit 21 has multiple evaporating tubes 210 with air channel 215. The evaporating tube 210 is composed of metal tube 211 covered with porous moisture absorbing material such as fiber cloth or non-woven cloth, These materials have water absorbing property, which have enormous small pores on their surface. After the metal tube 211 is covered by these materials and their pores are filled with water, a layer of water film is formed on the surface of metal tube 211. When the water is evaporated, the change of latent heat (the evaporation of 1 gm of water needs 539 cal of heat) will be used to cool the fluid (such as water) to be cooled in the metal tube 211. The water film on the metal tube 211 absorbs the heat and evaporates. The water vapor is sucked out of case by the fan 232, which is driven by the fan motor 231 in the air supply device. The cooling water is completely sealed in the metal tube 211. So, when the heat is released, the temperature difference of cooling water can be represented by the change of sensible heat.

The other specific design of the present invention is that no secondary cooling system is required, and water supply is periodical type instead of continuous type. The water supply device 24 uses tap water to feed into a water sprinkling device through a solenoid valve. When the solenoid valve is opened, tap water is automatically sprayed on the top of heat dissipating tube coil 21, which is absorbed by the porous moisture absorbing material 212 on metal tube 211. When the water in the porous moisture absorbing material 212 on metal tube 211 is saturated, the excess water will drop to the next porous moisture absorbing material 212 on metal tube 211 by gravity, until the lowest porous moisture absorbing material 212 on metal tube 211 is wetted. The cyclic time depends on the number of metal tube 211, but it always takes a few seconds to complete water supply process. If there still has excess water left, it can be discharged or recovered for reuse, and the recovered water is not required to be cooled again.

So, the biggest breakthrough of present invention is that it does not need circulating water used in common closed and non-closed cooling tower, the environmental problems such as noise, mosquito, and veteran disease etc. can be eliminated. In addition, it does not have the secondary cooling system and heat dissipating sheet of traditional closed cooling tower. Its features are low cost, light weight and small volume, and about the volume of traditional open cooling tower can reach the function of closed cooling tower.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1: The schematic diagram of traditional closed cooling tower.

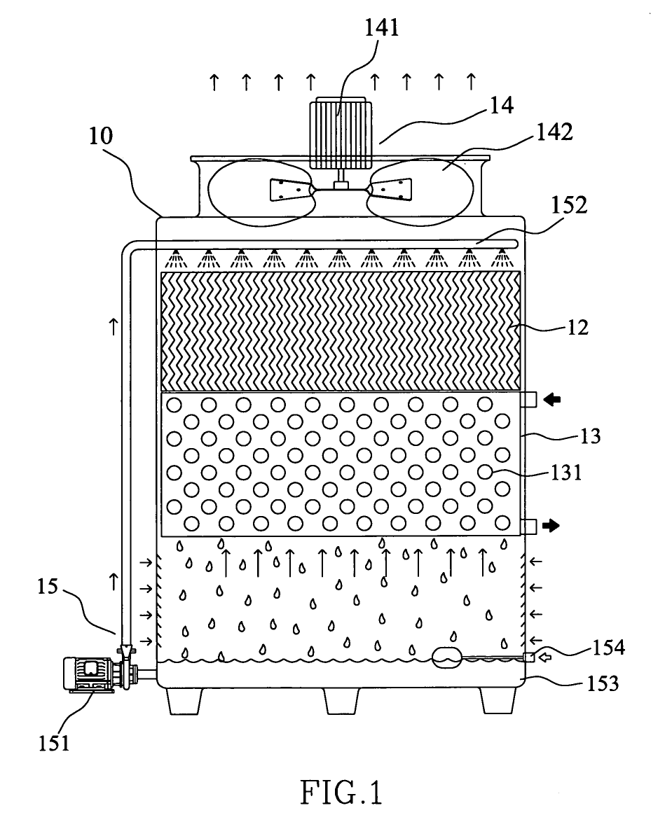

FIG. 2: The schematic diagram of the closed evaporative cooling tower of the present invention.

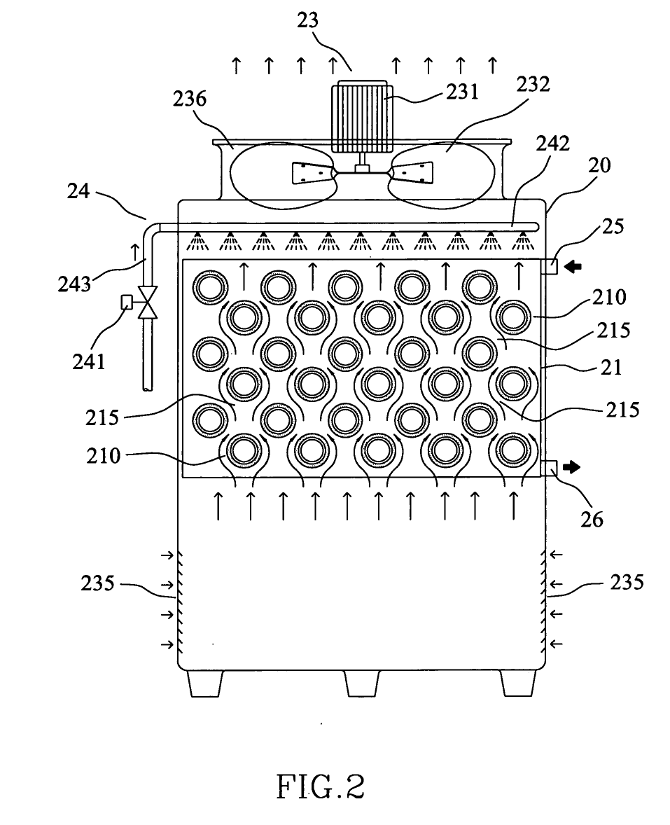

FIG. 3: The schematic diagram of the evaporating tube of the present invention.

FIG. 3A: It shows the metal tube is covered by porous moisture absorbing material to form the evaporating tube shown in FIG. 3.

FIG. 4: The schematic diagram of the internal structure of preferred embodiment of the present invention.

FIG. 4A: The first preferred embodiment of evaporative heat dissipating tube coil unit of the present invention.

FIG. 4B: The second preferred embodiment of evaporative heat dissipating tube coil unit of the present invention.

FIG. 5: The schematic diagram of the water supply device of the present invention.

FIG. 6: The schematic diagram of ON/OFF operation of solenoid valve.

### DESCRIPTION OF THE PREFERRED EMBODIMENTS

In order to let the reviewers know the purpose, feature and performance of the present invention better, it is described more clearly by the following preferred embodiments and drawings. The preferred embodiments are used for description only, which shall not limit the present invention. In addition to the detail description, the present invention can be applied broadly, and the scope of present invention is not limited, the claims shall be used.

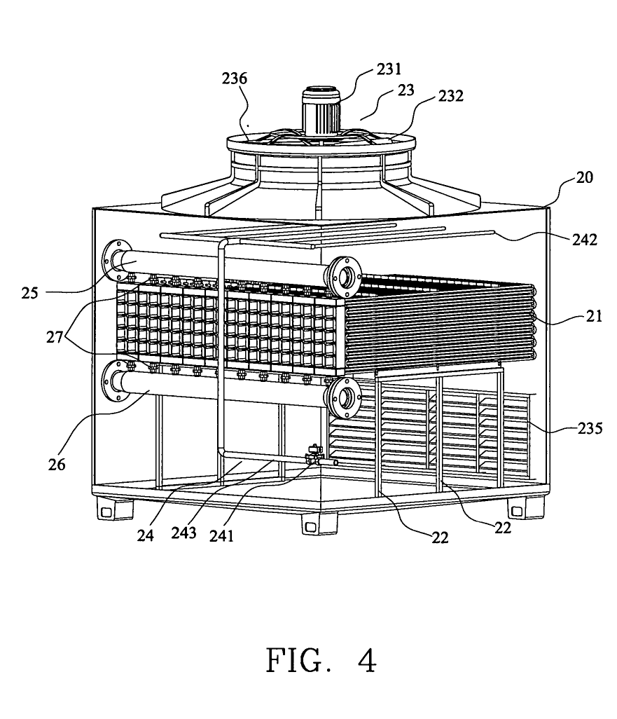

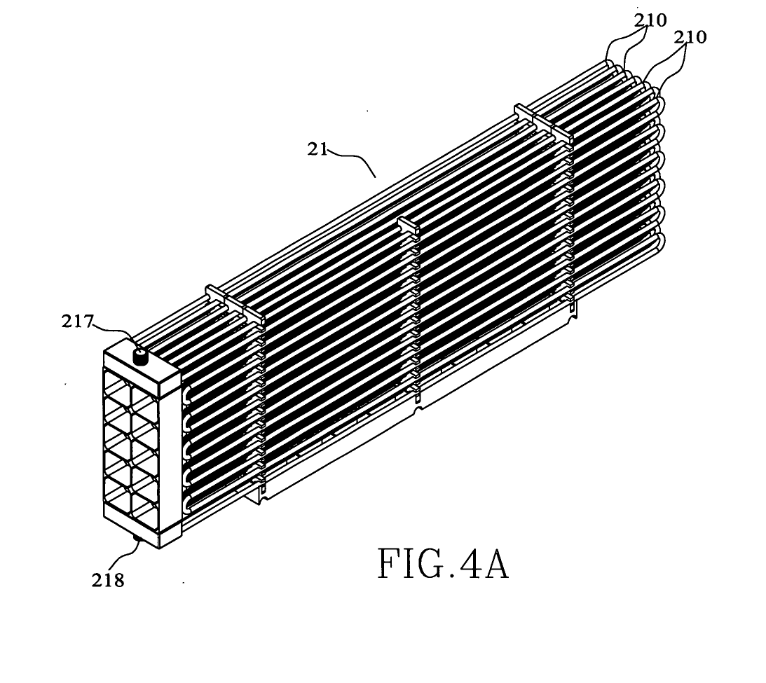

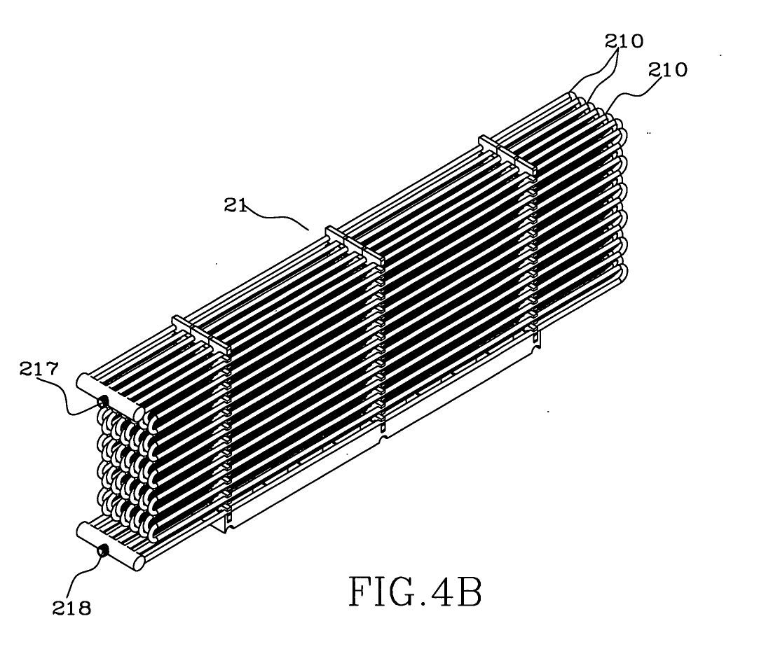

Please refer to FIG. 4 and FIG. 4A. There is an air supply device 23 in a case 20, comprising one or several intake air channels 235 and exhaust air channels 236. The fan motor 231 and fan 232 are installed in said air channel. Several heat dissipating tube coil units 21 are set in said air flow space and fixed on a supporting rack 22. Each heat dissipating tube coil unit 21 has an intake connector 217 and a discharge connector 218 for the input and output of fluid to be cooled (such as water). The metal or non-metal connecting pipe 27 is used to connect intake segregated flow pipe 25 and discharge combined flow pipe 26 to the intake connector and discharge connector, respectively. The fluid to be cooled is entering intake segregated flow pipe 25 at high temperature, and it is distributed to each heat dissipating tube coil unit 21 through the connecting pipe 27. The heat exchange process is occurred between the fluid to be cooled and metal surface in the heat dissipating tube coil unit 21. The cooled fluid is flowing out of heat dissipating tube coil unit 21 to the discharge combined flow pipe 26 through the connecting pipe 27. Countercurrent flow is used for the fluid to be cooled and the air flow in said space. The relationship of wet bulb temperature between the fluid to be cooled and the air flow is:

The air flow has the highest wet bulb temperature at the intake of fluid to be cooled (the air to be leaving the cooling tower), and the air flow has the lowest wet bulb temperature at the discharge of fluid to be cooled (the air entering the cooling tower), which can get the best heat exchange effect.

Please refer to FIG. 4B. It shows another preferred embodiment of the heat dissipating tube coil unit 21 in the present invention.

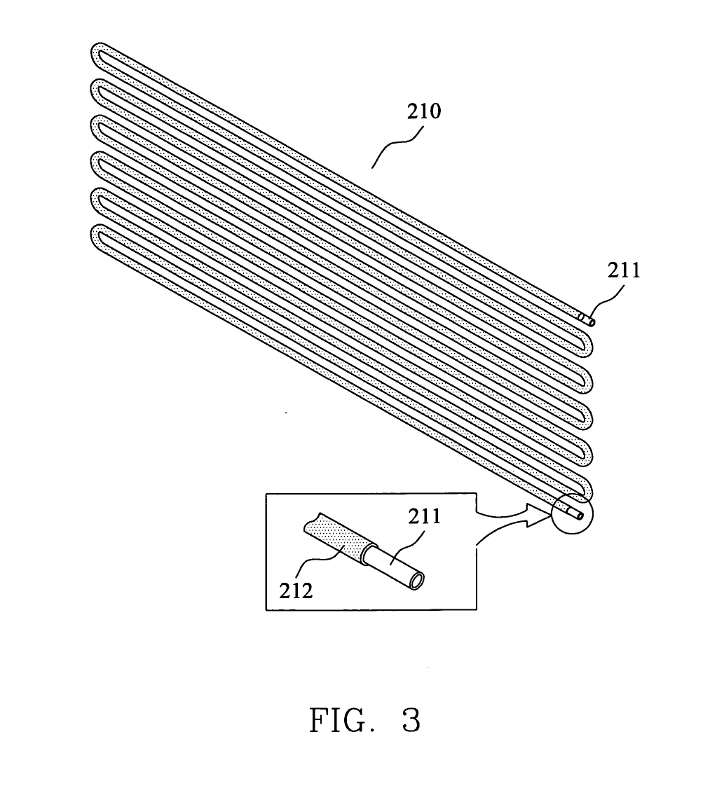

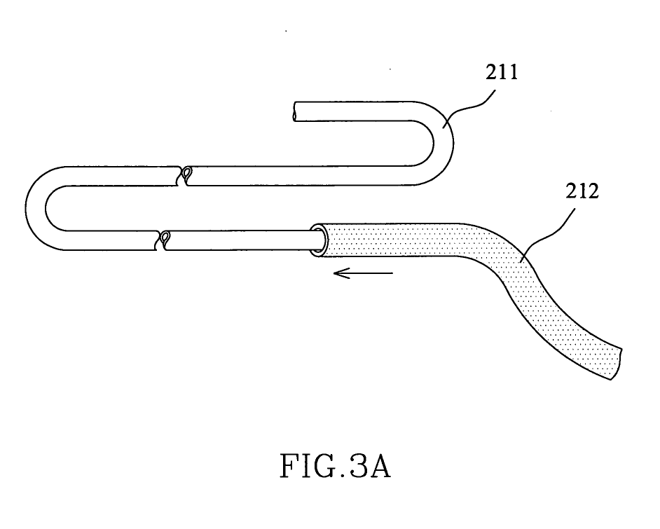

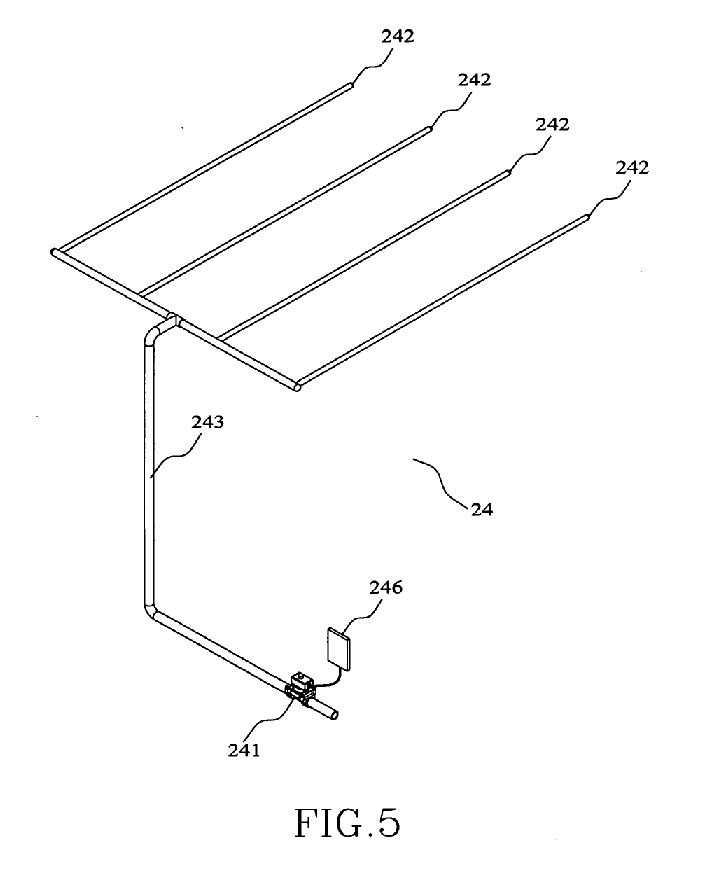

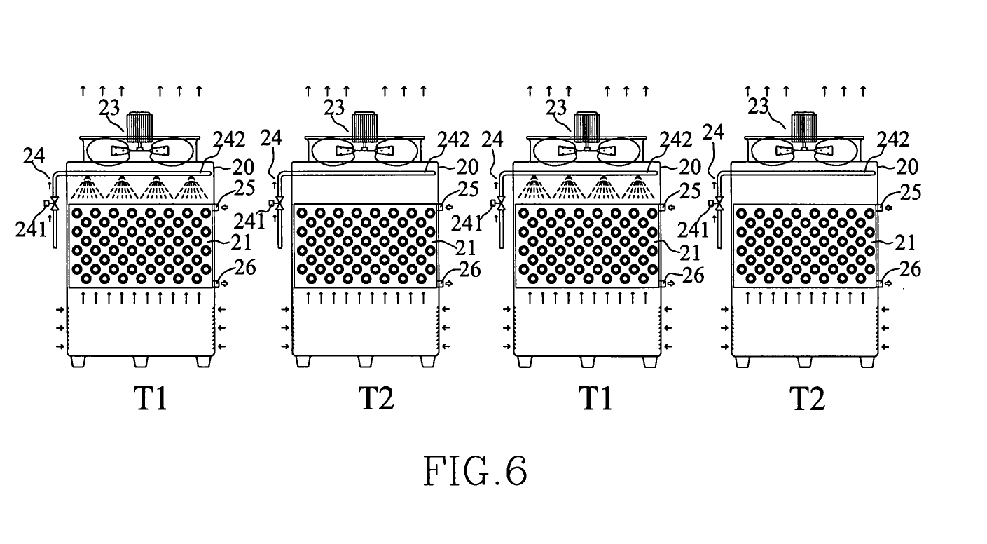

In addition, please refer to FIG. 3A. It shows the metal tube 211 is covered by porous moisture absorbing material to form a circular sleeve. The metal tube 212 is inserted into the flexible moisture absorbing material to form the evaporating tube 210, wherein the moisture absorbing material may be any material with moisture absorbing or keeping feature such as non-woven cloth, cloth, natural fiber or inorganic fiber etc. Please refer to FIG. 5. It shows another preferred embodiment of the present invention. In the space of said closed cooling tower, there is a set of water supply device 24 comprising one or several water sprinkling device 242, main water supply pipe 243, solenoid valve 241 and water supply controller 246 to get delay ON/OFF function. The major function of said water supply device 24 is to periodically provide water to sprinkle on the top of heat dissipating tube coil 21, which is absorbed by the porous moisture absorbing material 212 on metal tube 211 to wet the evaporating tube 210. Please refer to FIG. 6 for the water supply process. T1 is the open time of solenoid valve 241, and T2 is the closed time of solenoid valve 241. T1 and T2 can be set in fixed mode according the heat exchange duty of cooling tower or variable mode according the wet bulb temperature of air flow and the energy change of the fluid to be cooled.

What is claimed is:

1. A closed evaporative cooling tower, comprising:
a case having one or several intake air channels and exhaust air channels;
a heat dissipating tube coil unit having an intake connector and a discharge connector to let the fluid to be cooled flows through said heat dissipating tube coil to cool high temperature intake fluid through heat exchange in the evaporating tube;
a supporting rack for the fixation and support of heat dissipating tube coil unit;
an air supply device having a fan driven by fan motor to generate air flow, the air flow passes through the air channel in heat dissipating tube coil unit to evaporate the water in porous moisture absorbing material to cool the fluid in the metal tube so that large amount of heat can be exchanged;
an intake segregated flow pipe having a connecting pipe to connect the intake flow (such as water) to intake segregated flow pipe and at least a connector is installed;
a discharge combined flow pipe having a connecting pipe to connect the discharge flow discharge combined flow pipe and at least a connector is installed; and
a water supply device having a controller, a solenoid valve, one or several water sprinkling device and a main water supply pipe, so that water can be periodically provided to sprinkle on the top of heat dissipating tube coil , which is absorbed by the porous moisture absorbing material.

2. The closed evaporative cooling tower of claim 1, wherein the heat dissipating tube coil unit comprises the metal tube covered by porous moisture absorbing material to form the evaporating tube, and the coverage way depends on the cross-sectional shape of metal tube. The intake end and discharge end of the evaporating tube can form a loop, which can be a straight tube or separated straight tube, and the evaporating tube is the major element of the heat dissipating tube coil unit.

3. The closed evaporative cooling tower of claim 2, wherein the metal tube is inserted into the sleeve of flexible moisture absorbing material directly.

4. The closed evaporative cooling tower of claim 2, wherein the evaporative heat dissipating tube coil unit also comprising:
at least a fixing plate to fix several evaporating tubes and reserve air flow channel in the evaporating tubes;
an intake flow distributing device to distribute the fluid to be cooled to each evaporating tube for heat exchange and set a connecting pipe; and
a discharge flow combining device to combine the fluid which has been cooled from each evaporating tube and set a connecting pipe.

5. The closed evaporative cooling tower of claim 1, wherein several connectors are set at the intake segregated flow pipe and the discharge combined flow pipe, and metal pipe or non-metal pipe is used to connect them to the device specified in claim 4 and the connectors of heat dissipating tube coil unit.

6. The closed evaporative cooling tower of claim 1, wherein the water supply system comprising one or several water sprinkling device, a solenoid valve, a water supply controller and a main water supply pipe, The ON/OFF operation is controlled by the solenoid valve based on the command of water supply controller to control the sprinkling time of the sprinkling device.

7. The closed evaporative cooling tower of claim 6, wherein the water supply controller is executing the commands of delayed ON and delayed OFF, the time of delayed ON and delayed OFF depends on the temperature difference of intake fluid and discharge fluid to be cooled to get variable mode.

8. The closed evaporative cooling tower of claim 6, wherein the time of delayed ON and delayed OFF can be set in a fixed mode for the requirement of commissioning and maintenance, and there is a key for the switch.

9. The closed evaporative cooling tower of claim 6, wherein the command of water supply controller can be adjusted for the phase change of the fluid to be cooled in the closed cooling tower and the pressure is used.

10. The closed evaporative cooling tower of claim 6, wherein the sprinkling device can be fixed shape with multiple water discharge holes or nozzles, the water sprinkle mode may be fixed type or rotating 360 degrees freely.

11. The closed evaporative cooling tower of claim 1, wherein the fluid to be cooled can be water or any chemical fluid.
